(19) United States
(12) Patent Application Publication
(10) Pub. No.: US 2014/0330417 A1
(43) Pub. Date: Nov. 6, 2014

(54) ADAPTABLE 3D PATIENT IMMOBILIZATION

(71) Applicant: John Keane, Oakdale, NY (US)

(72) Inventor: John Keane, Oakdale, NY (US)

(21) Appl. No.: 14/271,149

(22) Filed: May 6, 2014

Related U.S. Application Data
(60) Provisional application No. 61/819,812, filed on May 6, 2013.

(51) Int. Cl. G06F 17/50

(52) U.S. Cl. CPC G06F 17/50
USPC 700/98; 700/97

(57) ABSTRACT

A method for customizing, based on medical imaging data for a patient positioned on a treatment couch, a medical immobilization device is disclosed. Medical imaging data, for example, CT image data, MRI image data or the like, is received, and a selection is made of an immobilization device that anchors only to at least one boney structure of a body part of the patient to immobilize the body part of the patient. The immobilization device may mask only partially the body part of the patient. The device can be customized and an image of the patient can be repositioned without obtaining additional imaging data from the patient. The at least one boney structure may be an orbital area and a chin, an elbow, or a knee and groin area. The immobilization device may be attachable to a support structure positioned underneath the patient on the treatment couch.

### CROSS-REFERENCE TO RELATED APPLICATION

The present nonprovisional patent application claims the benefit of priority from U.S. Provisional Patent Application No. 61/819,812 filed on May 6, 2013, entitled “ADAPTABLE 3D PATIENT IMMOBILIZATION,” the entire content of which is incorporated herein by reference.

### BACKGROUND

1. Field of the Disclosure

The present disclosure relates to the field of patient immobilization device generation for medical procedures, and to radiation therapy immobilization device customization, including eye and chin masks, head masks, braziers, boluses, headrests, patient support structures, bite blocks, upper bite mold, and associated custom mounting structures and their customization and production, including 3D printing.

2. Background of the Disclosure

A variety of medical procedures require immobilization of a patient for precise positioning of a patient. In the field of radiation oncology, precise positioning of a patient is of particular importance as radiation is administered. Typically, radiation oncology entails the exposure of sensitive or high-risk portions of human body, and requires planning, such as a CT (x-ray computed tomography) simulation, before radiation treatment can begin. With the benefit of CT imagining, radiation treatment can be planned for a target volume, such as a tumor, and can avoid organs at risk (OAR), such as the spinal cord or visual structures. Virtual simulation, including simulation in three-dimensions, for example, using patient images displayed on an electronic display, projection or monitor, can also be used for three-dimensional conformal radiation therapy. A treatment plan can be generated, for example, with the aid of specialized software by radiation oncologists, radiation therapists, medical physicists and/or medical dosimetrists to deliver a prescribed dose of radiation to the target volume, while minimizing unwanted radiation to OARs. Several types of more recently developed forms of treatments include Intensity-Modulated Radiation Therapy, tomotherapy, proton therapy and other kinds of particle therapy, and image-guided radiation therapy.

Presently, to implement a successful treatment plan, the patient must be precisely positioned during the radiation treatment to deliver the required radiation dosage to the target volume while avoiding or minimizing the radiation field delivered to OARs. This precise positioning must often be identical during the positioning during the CT simulation to that during treatment planning, and must also be repeated during the course of the radiation therapy. That is, during the treatment planning process, the radiation fields delivered as part of the radiation therapy are designed to sculpt precisely the delivered dose to the target volumes while avoiding OARs. Such a treatment plan typically requires that the patient be positioned repeatedly within 5 mm of the positioning of the initial CT simulation. Such radiation therapy can be repeated daily or regularly over a six week time period. In addition, the patient anatomy can change, for example, the patient may lose weight during the course of the radiation therapy. For stereotactic radiation treatment, the patient typically needs to be positioned within 1 mm of the position during initial CT planning. This precise positioning requires simulation immobilization devices to assist in the positioning of the patient. FIG. 1 illustrates a head mask for a patient that could be made during the CT simulation and planning process for a head and neck cancer patient.

Currently in a radiation therapy facility, a patient comes for a simulation CT and devices are made to immobilize the patient in the same position for the entire course of their treatment. The CT data set is transferred via DICOM RT to the treatment planning computer. The tumor volume and critical structures are drawn by the physician and the physician prescribes a dose of radiation to the tumor volume. The next step is for a dosimitrist or physicist to generate a treatment plan that delivers the prescribed dose to the tumor while minimizing the dose to surrounding critical structures and normal tissue.

Although radiation oncology and medical imaging have advanced considerably over the past decade, the standard of care in the CT simulation process and immobilization device generation has remained largely unchanged. Machines have been delivering more sophisticated radiation fields. However, a simulation technician would make immobilization devices today very similar to those made ten years ago.

Due to the position in which the patient was simulated with respect to the tumor volume and critical structures along with the limitations of the treatment device, the plan that is generated by the dosimitrist/physicist may not be optimal.

For example, a LINAC (linear accelerator) or a proton therapy system may have three degrees of freedom—the gantry, treatment couch, and collimator, to rotate around a patient as the patient is immobilized on the treatment couch. FIG. 12 shows that in order to irradiate a brain tumor T from the anterior position A, the radiation would need to pass through the patient's eyes. This would likely cause damage to a critical structure and must be avoided. The planning dosimitrist/physicist has a couple options: 1) avoid using the anterior fields as the gantry rotates around the patient to protect the patients eyes. This results in a less conformal dose distribution. 2) return to the simulation phase with the patient in a different position (head down).

Giesel, U.S. Pat. No. 8,369,925, teaches prototyping of a mask for treatment that includes a positive or a negative offset of a surface of the mask, and that an STL (Stereo Lithography) file is sent to a 3D printer to prototype rapidly the mask. Bova, U.S. Pat. No. 7,651,506, discloses frameless guidance of image-based medical procedures such as stereotactic radiotherapy and surgery, and devices that include custom fitting subject-specific articles that include contoured services that provide special reference to the location of target regions within the subject. Giesel, U.S. Pat. No. 8,369,925 and Bova, U.S. Pat. No. 7,651,506, are both fully incorporated herein by reference.

Often in a clinic setting, immobilization masks, such as head and neck mask, is made by heating thermoplastics and then placing it on the patient, such as the patient's head, and then waiting for the mask to dry to form a surface model of the patient's body part. The following are some of the disadvantages of the surface model approach to generating a mask: Patient anatomy can change over time, except around boney structures. The patients often require a course of treatment of up to six weeks, over which time the patient can gain or lose weight. This is particularly true of patients who are undergoing chemotherapy. The surface contour made during the initial simulation will then no longer conform to the patient anatomy. A mask or other immobilization device that does not conform well to the patient's anatomy can lead to patient discomfort due to the improper fitting of the mask. Patients who are uncomfortable tend to move to alleviate discomfort into a position that is unfavorable for treatment because it will not be the same position as during the simulation. Improper positioning of the patient can lead to failure in delivering an effective dose to the target area, the delivery of harmful radiation to sensitive areas, and may require the repositioning of the patient and/or the readministering of the radiation.

It may be difficult to manufacture masks that conform to the patient's total surface contour. Such masks can require additional data input and introduce additional fit requirements that can be off during the production process. Also, hair of the patient can disrupt the conforming of the mask to the patient.

In addition, a full mask can act as a bolus to the patient's body and may increase skin dose of radiation in unwanted or undesirable areas of the patient's body. A non-custom patient support structure can inhibit the effectiveness of the immobilization mask.

### SUMMARY OF THE DISCLOSURE

A method, system, means for, device and non-transient automated processor readable medium are disclosed for customizing, based on medical imaging data for a patient positioned on a treatment couch, a medical immobilization device. The method includes: receiving, by an automated data processor, for example via an electronic transmission, the medical imaging data;

receiving, by the automated data processor, a selection of an immobilization device configured to anchor only to at least one boney structure of a body part of the patient to immobilize the body part of the patient the immobilization device configured to mask only partially the body part of the patient;
customizing, by the automated data processor, the selected immobilization device according to the medical imaging data; and
outputting, by the automated data processor, a signal for producing the immobilization device according to the customized immobilization device.

For example, the signal output may be sent to a machine, such as a 3D printer, for building or producing the immobilization device.

In this method, the patient medical imaging data may include at least one of a cone beam CT image data, a CT scanner image data, an x-ray image data, an MRI image data, or a laser system image data.

The at least one boney structure may consist of at least one orbital area and the body part is the head. The at least one boney structure may consist of at least one orbital area and a chin, and the body part is the head. The at least one boney structure may consist of an elbow and a shoulder. The at least one boney structure may consist of a knee and a groin area.

The immobilization device may be attachable to a support structure positioned underneath the patient on the treatment couch, and the method may further include outputting, by the automated processor, a second signal for producing the support structure to which the medical immobilization device is attachable.

This method may further include receiving, by the automated processor, a repositioning instruction and repositioning an image of the patient according to the repositioning instruction, the repositioning performed based on the medical imaging data without obtaining further imaging data from the patient.

This method may further include generating a display comprising the immobilization device superimposed on the body part of the patient on the repositioned image.

This method may further include receiving, by the automated processor, an instruction for adding a marking to the medical immobilization device, including an isocenter marking; and outputting a signal for marking the medical immobilization device according to the instruction for adding the marking.

The immobilization device may be attachable to a support structure positioned underneath the patient on the treatment couch, and wherein the support structure comprises a custom headrest.

The immobilization device may be attachable to a support structure positioned underneath the patient on the treatment couch, and wherein the support structure comprises an arm support structure.

The immobilization device may be attachable to a support structure positioned underneath the patient on the treatment couch, and wherein the support structure comprises a leg support structure.

The immobilization device may be attachable to a support structure positioned underneath the patient on the treatment couch, and

wherein the immobilization device comprises a custom bite block and custom bit mold. The immobilization device may comprise a bite block, or may comprise a brazier.

The immobilization device may be attachable to a support structure positioned underneath the patient on the treatment couch, and wherein the immobilization device comprises a custom torso immobilizer.

The immobilization device may be attachable to a support structure positioned underneath the patient on the treatment couch, and wherein the immobilization device comprises a custom hip immobilizer.

The immobilization device may be attachable to a support structure positioned underneath the patient on the treatment couch, and wherein the immobilization device comprises a custom back immobilizer.

Such a method may further include receiving, by the computer, a three dimensional image of the patient; and outputting the three dimensional image of the patient to a user, before receiving the medical immobilization device customization instruction.

Also contemplated is a method of customizing, based on medical imaging data for a patient positioned on a treatment couch, a brazier, the method comprising:

receiving, by an automated data processor, for example via an electronic transmission, the medical imaging data obtained with the patient in a prone position;
receiving, by the automated data processor, a selection of a brazier immobilization device configured to hold a breast of the patient;
outputting, by the automated data processor, a signal for producing the brazier according to the selection; and
positioning the patient in a supine position using the brazier.

This method may further include causing, by the automated data processor, display of an image of the patient in a supine position without obtaining further imaging data from the patient.

### BRIEF DESCRIPTION OF THE FIGURES

FIG. 1 illustrates a head mask for a head and neck cancer patient, according to the related art.

FIG. 2 is a high-level diagram showing an example of the interaction of components for an customizable and adaptable 3D-imaging data-based immobilization process, according to an aspect of the present disclosure.

FIG. 3 is a flowchart illustrating steps of customizing an immobilization device, according to an aspect of the present disclosure.

FIG. 4 is an example of a device generation engine for generating a customized treatment device, according to an aspect of the present disclosure.

FIG. 5 illustrates top and side images of an example of a treatment device with a bolus, according to the related art.

FIG. 6 illustrates an example of headrest according to the related art.

FIG. 7 illustrates an example of markings positioned on an immobilization device to aid in radiation field delivery, according to an aspect of the present disclosure.

FIG. 8 is a flowchart illustrating steps of selecting an immobilization device from a library and customizing the same, according to an aspect of the present disclosure.

FIG. 9A illustrates an example of an immobilization device in the head extender position with the head fixed toward the left position according to an aspect of the present disclosure.

FIGS. 9B and 9C illustrate examples of an immobilization device in the head extender position with the head in the straight position illustrated in FIG. 9B, and with the head fixed toward the right position illustrated in FIG. 9C, according to an aspect of the present disclosure.

FIGS. 9D-9F illustrate examples of the immobilization devices for the head in the head neutral position. FIG. 9D illustrates an immobilization device for the head neutral position with the head fixed toward the left, FIG. 9E with the head straight, and FIG. 9F with the head secured toward the right, according to an aspect of the present disclosure.

FIGS. 9G-9I illustrate examples of immobilization devices in the head down position. FIG. 9G illustrates the head down position with the head toward the left, FIG. 9H with the head down, and FIG. 9I with the head toward the right, according to an aspect of the present disclosure, according to an aspect of the present disclosure.

FIGS. 10A-10C illustrate repositioning of a patient with spine disease, according to an aspect of the present disclosure.

FIGS. 11A-11D show positioning for electron radiotherapy, according to an aspect of the present disclosure.

FIG. 12 illustrates a problem of providing radiation therapy for a brain tumor from an anterior position while avoiding critical areas.

FIG. 13 illustrates an upper bite and palate.

FIG. 14A illustrates an example of an immobilization device for the frog legged position for a leg, according to an aspect of the present disclosure.

FIG. 14B illustrates an example of an immobilization device for an arm, according to an aspect of the present disclosure.

FIG. 15A-15F illustrate a bra for providing radiation to a breast, according to an aspect of the present disclosure.

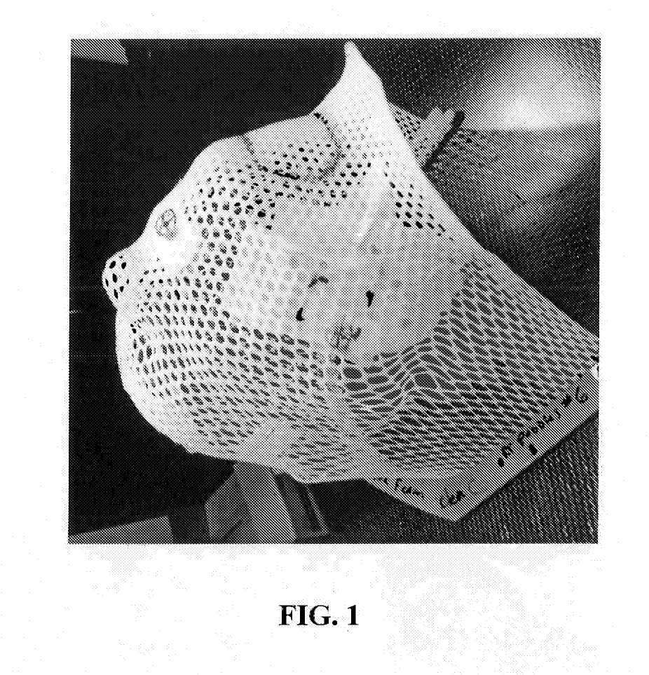

### DESCRIPTION OF THE DISCLOSURE

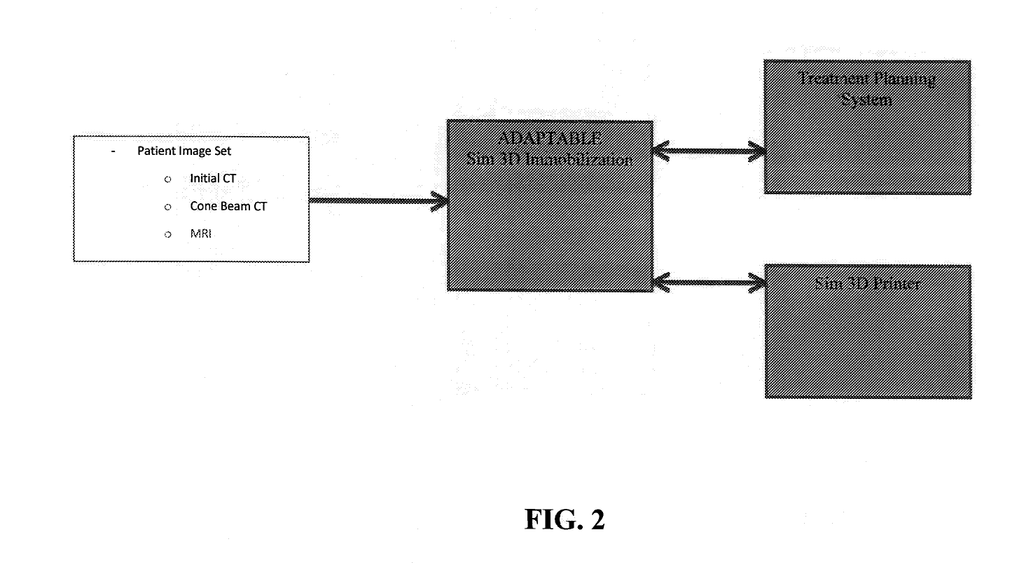

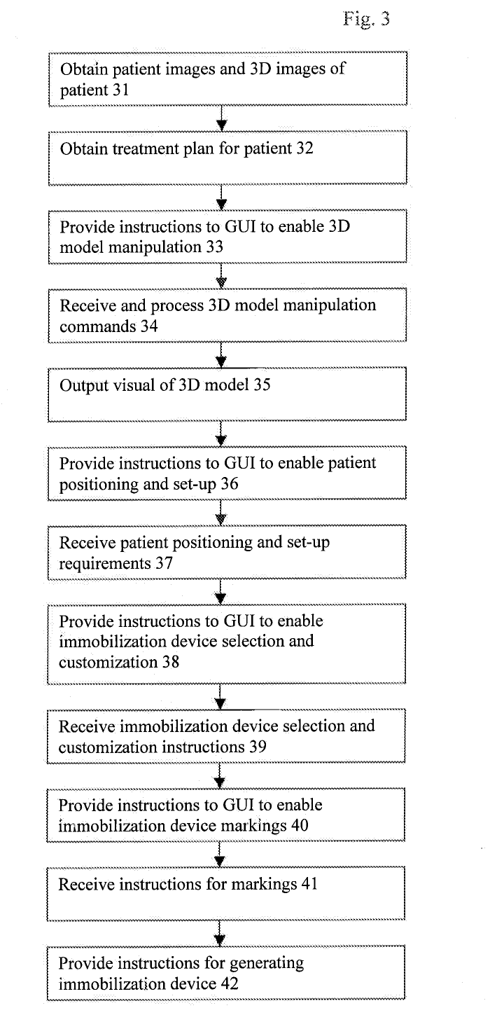

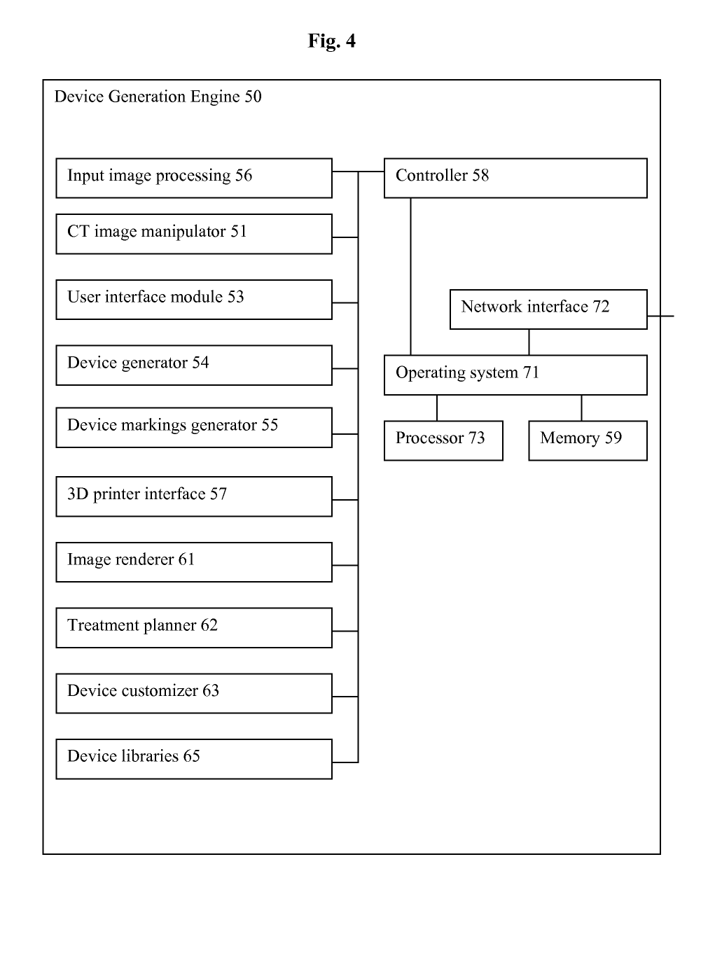

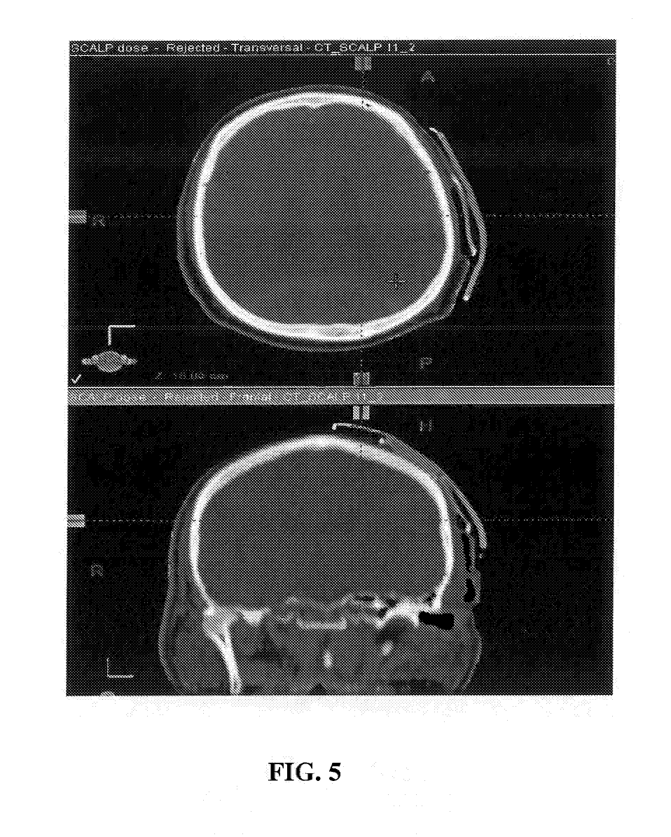

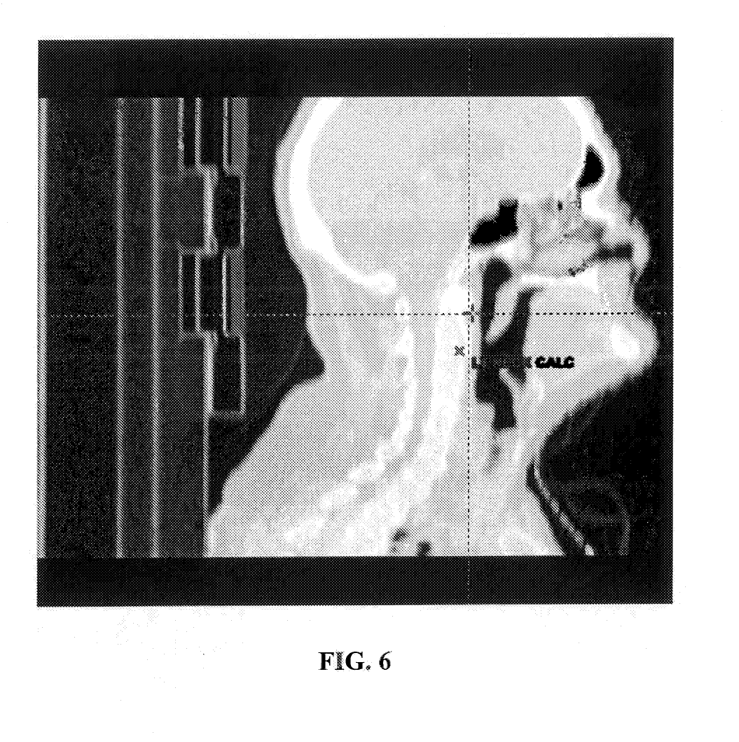

Aspects of a method, process, system, computer-readable medium or the like will now be described with reference to FIGS. 3 and 4. Medical imaging data for a patient, such as an image from a CT scanner, a cone beam CT scanner, an MRI (magnetic resonance imaging) positron emission tomography device, a laser system, or a combination of the foregoing, are obtained by input image processing 56 of device generation engine 50 illustrated in FIG. 4, and shown at step 31 of the flowchart shown in FIG. 3. For example, a CT scanner may supply the image to a processor, which may generate a DICOM (digital imaging and communication for medicine) format image to the device generation engine 50 illustrated in FIG. 4. However, it will be understood that other types of medical imagining equipment, technology, and formats and other transmission protocols may also be used to generate, to communicate, to transmit, or to process, the patient image to the system. While sometimes described herein as a CT image, it will be understood that many such images can comprise or be part of the same image set. FIG. 2 illustrates the patient image set, such as initial CT images, a cone beam CT images, or MRI images being transmitted to the adaptable immobilization system, such as the device generation engine 50. The device generation engine 50 is also in communication with the treatment planning system and the 3D printer.

One or more 3D images for the patient's anatomy may be obtained to aid in the device planning process. The 3D image can be understood as a set of images, for example, top, side, front view images and the like, and may be obtained from a variety of sources and using various types of imaging technology. While described herein as external devices and equipment, the treatment planning system, the 3D image obtaining system, and the CT, MRI etc. imaging system may all be configured as part of the same system or may be run on one or more machines connected to the device generation engine 50. Also the planning CT image can be manipulated, for example, enlarged, shrunken, rotated, transposed or overlaid or a different image, or the like, to change a patient's position to optimize treatment field geometry.

A study of the lattice structure of various masks has revealed to the inventor that the integrity and fit of the mask and how well the mask immobilizes are determined by certain key areas of the mask. For example, the chin and eye sockets/orbital area for the head mask, and not the entire surface contour of the mask, are/is often critical in this respect. A total surface model is unnecessary to mobilize a patient and can be detrimental as discussed above.

According to an aspect of the present disclosure, the type of patient immobilization device desirable for treating a particular patient can be retrieved from a library of data that contains site-specific models that conform to specific boney structures of the anatomy. These anchor points of the device secure to the boney structures for which they are designed and are sufficient for immobilization of the patient or of a body part of the patient, such as the head, a limb, or the like. For example, a surface mask over a patient's nose does not significantly aid in patient immobilization. In fact, such a mask can irritate the patient due to patient discomfort and can tend to urge movement of the patient out of the desired position on the treatment couch. This is especially true if the mask does not properly fit the patient.

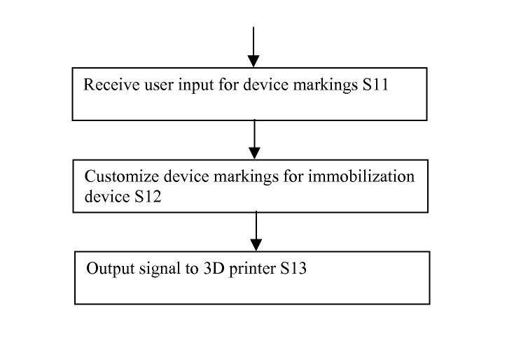

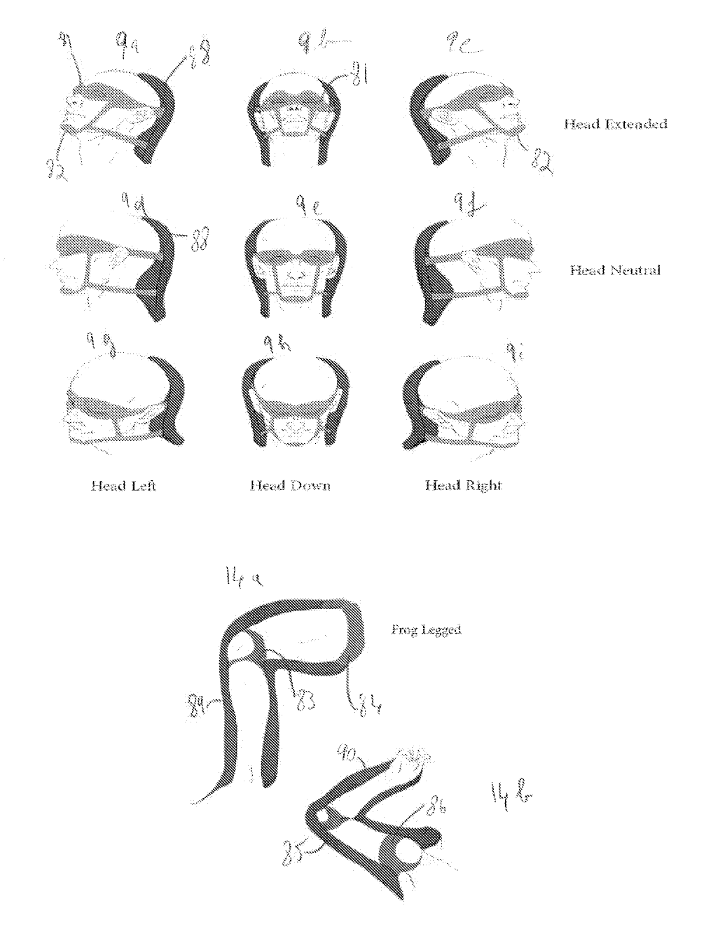

FIGS. 9a-i are examples of site-specific immobilization device files that can be provided as part of a system according to an aspect of the disclosure. Such a library of customizable devices can insulated the user from having to design immobilization devices from scratch for each patient. FIGS. 9a-c illustrate an immobilization device 81, 82 for the head extended position, which immobilizes the head around the orbital area and forces the chin up, respectively. The immobilization device can include just one of orbital portion 81 and chin portion 82. Also, orbital portion 81 and chin portion 82 may be provided as one integrated unit.

Also illustrated is a custom support structure or headrest 88 that is designed to be positioned underneath the head of the patient such that the immobilization device is attached/secured to the headrest. FIGS. 9a-9c illustrate examples of immobilization devices for the head to the left, head straight and head to the right, respectively. FIGS. 9d-f illustrate the head in neutral position in which the immobilization device 81, 82 is anchored at the orbital area and chin, respectively to keep the mandible immobilized. FIGS. 9d-9f illustrate examples of immobilization devices for the head to the left, head straight, and head to the right, respectively. A custom support structure 88 is also illustrated.

FIGS. 9g-i illustrate an immobilization device for the head down position using the orbital area and chin as the anchors. FIGS. 9g-9i illustrate examples of immobilization devices for the head to the left, head straight and head to the right, respectively. The custom support structure raises the head up and forces the chin down. As will be understood, the custom support structure or headrest can be integrated with and generated as part of the immobilization device on the front and sides of the head.

FIG. 14a illustrates an immobilization device 83, 84 for the frog legged position, in which the immobilization device is anchored at the knee and groin area, respectively. Also illustrated is the custom support structure 89 that is positioned under the leg on the treatment couch and to which the immobilization device is attached. Immobilization device 83, 84 may be integrally formed as one unit. Knee portion 83 and crouch portion 84 of the device may each be provided alone as the immobilization device without the other.

FIG. 14b illustrates an immobilization device 85, 86 that anchors at the elbow and armpit, respectively, and also illustrates a custom support structure 90 underneath the arm and resting on the treatment couch. Immobilization device 85, 86 may be formed as an integrally formed unit. Elbow portion and shoulder portion 86 may each be provided alone as the immobilization device without the other In each case, the custom support structure may be positioned under the body part to be immobilized and can be attached directly to the immobilization structure. The custom support structure can be customized to the patient's body together with the immobilization device. The immobilization device and the custom support structure underneath the body part together may be thought of as one immobilization device, and, optionally, can be produced as a single unit, which may be integrally formed.

In an alternate implementation, the support structure underneath the patient's body part to which the immobilization device is attached or otherwise secured can be a standard support structure for the body part and one that is not specifically customized or fitted for the patient custom immobilization devices as described herein may be attached directly to the treatment couch. As a further alternative, no customized support structure for underneath the patient is necessary, and the customized immobilization device can be secured directly to the treatment couch.

A treatment planning system, illustrated in FIG. 2, can provide input to the device generation engine 50, and can also be configured as part of the device generation engine 50 or as a separate module with which device generation engine 50 communicates. A variety of radiation treatment planning systems are known. Treatment planning system provides information about the dosage and target areas of radiation, as well as OARs, and related information concerning the treatment plan. A device generation system according to an aspect of the present disclosure includes a number of modules. While described herein as software modules, it will be understood that the system can be implemented as software, hardware, firmware, or as a combination of the foregoing, and that they may be implemented as part of, or to be executed by, one or more machines.

As shown in FIG. 3, at step 32, the treatment plan is obtained for the patient and the graphical user interface (GUI) is sent instructions to provide an interface to enable and facilitate manipulation, including rotation, enlarging, shrinking, transposing on a different image, or the like, of the 3D model at step 33 of FIG. 3. Graphical user interface module 53 creates the graphical user interface with which the user, such as a physician or technician, interacts and receives instructions and input to the GUI. The graphical user interface allows the user to manipulate the input image set to design desired immobilization devices. The 3D model manipulator 52 in FIG. 4 enables manipulation, including rotation, transposing on a different image, or the like, of the patient 3D model using the graphical user interface.

According to an aspect of the present disclosure, using the existing medical imaging data for the patient, the patient's position can be changed as necessary as part of the planning stage, after the conclusion of the simulation stage. Such repositioning or reorientation of the patient to a more favorable position for planning and treatment may be performed without exposing the patient to further CT or medical imaging.

According to an adaptive concept of the present disclosure, for example, sometimes a better treatment plan can be generated if the patient is in a slightly different position. For example, a slightly different head position could yield a better treatment plan for a brain tumor and avoid an organ at risk (for example, optical apparatus). The patient's position could be modified virtually and/or visualized on a monitor, and a custom immobilization device could thus be designed and manufactured based on the new virtual position. In this way, CT and other simulation imaging can be minimized, patient discomfort and exposure to CT minimized, and simulation and planning resources and costs optimized.

In addition, using the system, the user can also manipulate, such as rotate or change on screen, views of the immobilization device to test various implementations and configurations. In this way, the user can arrive at the immobilization device that is needed based on the treatment plan, given the patient's anatomy.

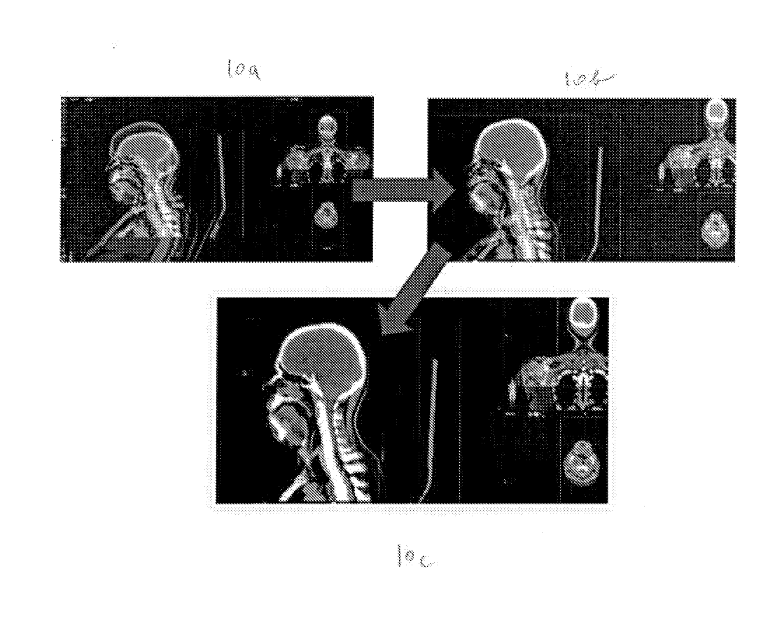

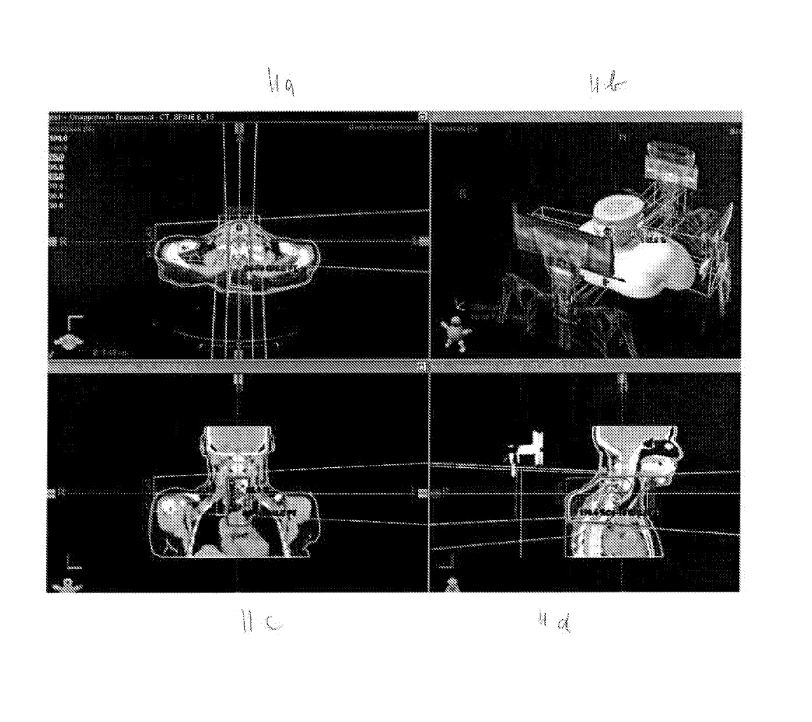

As illustrated in FIG. 10, for a patient with a spine disease, if posterior/anterior or anterior/posterior field were irradiated, the radiation dose would go through the patient's chin and mouth. However, if the patient's head is in the extended position, as illustrated in FIG. 10b and c, this could be avoided. Using the adaptable approach, the position of a patient's head can be changed in the planning process and the library of immobilization devices can be used to rapidly prototype an immobilization device to immobilize the patient in the optimal position.

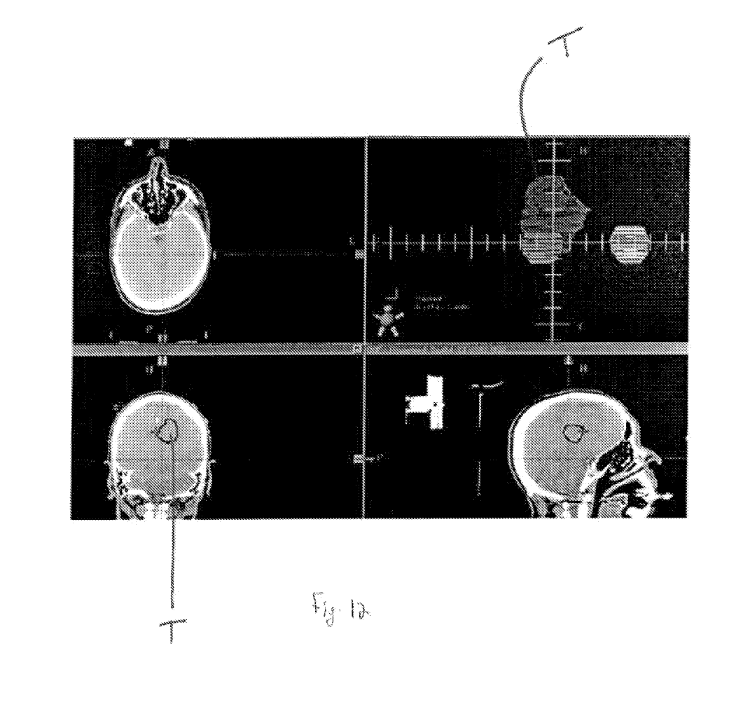

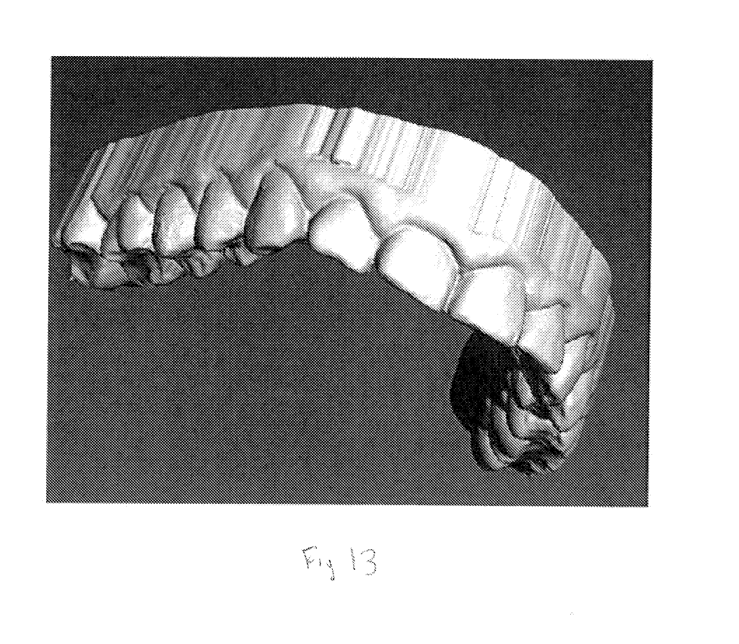

As illustrated in FIG. 11a-d, it is critical, due to the limited range of the electrons being transmitted by electron radiotherapy equipment, that the treatment field is enface directly with the patient to ensure proper dose distribution. That is, air gaps/curved surfaces can lead to underdosing or overdosing the tumor volume. Accordingly, the radiation therapy dosage can be improved if the planner is able to adapt the treatment position as part of the planning stage and can subsequently rapidly prototype the immobilization device in accordance with the newly arrived at adapted patient position.

Further, the bolus can be sized and positioned with precision, customized for the patient. For example, a bolus is most effective if it is in direct contact with the skin so that the radiation dose can be delivered. This is due to the principle of electron equilibrium, and an air gap can interfere with the effectiveness of the delivery. A custom head mask with bolus can make for a more precise radiation dosage because the bolus can be built up such that it is in direct contact with the skin, and is in contact with the skin exactly where it is needed. A custom nose bolus can be made to compensate for the surrounding lack of tissue and can be made to conform to patient's nose. In addition, a mounting structure to support any of the immobilization devices can also be designed in this way with precision and confidence.

While described as an “immobilization device,” it will be understood that a custom bolus or a combination of an eye, eye/chin, or head and neck mask or a head mask with bolus, shielding, a bite block, a neck mask, a head rest, a patient support structure, a torso support/immobilizer, a back support/immobilizer, a hip support/immobilizer, a leg support/immobilizer, an arm support/immobilizer, or the like can all be thought of as an immobilization device or a medical immobilization device as used herein. While described as an immobilization device, the customizable structures described herein are sometimes referred to as customizable device and need not actually immobilize the patient or need not immobilize the patient completely.

A customizable immobilization device can lead to better patient safety since, for example, a conventional headrest is not totally conformable to the contours of the head, and thus the head can be positioned on the headrest differently at different times. This can result in varying resulting angles for the spinal cord and thus, since the OAR is not in the same position, an overdose of radiation can result to the spinal cord. Similarly, because of the different possible positioning on the headrest, the correct dosage of radiation to the tumor volume can be missed. A custom headrest according to an aspect of the present disclosure can yield improved patient safety and patient outcome.

Also contemplated are custom built-in compensators and custom patient phantoms. It is customary at times to verify the dose to be delivered to a patient by measuring in a phantom prior to treatment. The issue does arise that how close does the phantom measurement set-up match the geometry used to treat the patient. A custom phantom can be made that exactly replicates the immobilized patient's geometry, shape and anatomy.

Also contemplated is a 3D brazier system to allow simulation in one position, and then planning and treatment in a second modified position of a patient. For example, a patient with breast cancer must be treated so as to avoid excessive radiation dosage to the patient's lungs and heart. When treating the patient in the supine position, the patient's breasts tend to fall laterally due to the effect of gravity, particularly in older patients. If treating using standard tangents, the lateral border must be moved posteriorly, that is toward the back plane of the body, to ensure that all the breast tissue is encompassed in the tangential field and treated according to the prescribed radiation dosage. However, this can cause an increase in dosage to the lung and heart.

Recently, some have been treating breast cancer with the patient lying in the prone position to bring the breast tissue away from the lung and heart. However, such a technique in the prone position can have the effect that the radiation therapist cannot see the entry or exit of the radiation fields, and thus, if the therapist does not set up the patient correctly, the contralateral breast can be exposed to the treatment field and thus receive radiation by mistake. In fact, in a number of clinical settings using this technique, the contralateral breast has been filmed in the treatment field. A further problem is that if the supraclavicular area of the patient needs to be treated, the prone technique cannot be used.

According to an aspect of the present disclosure, the patient is positioned in the prone position for the simulation phase to obtain a CT image or laser scanner image. A patient specific mesh 3D brazier can be rapidly prototyped, for example using 3D printing, customized for the shape and size of the patient's breasts. The patient can be simulated in the prone position and then planned and treated in the supine position. The mesh 3D bra can thus prevent the breast from falling out laterally, and as a result, can reduce the radiation dose to the lung and heart. Since the patient is treated in the supine position, the radiation therapist can verify the radiation field with the light field to ensure that the contralateral breast lies out of the treatment field.

In addition, a custom patient mesh 3D bra could immobilize the patient for using intensity modulated or volumetric modulated ARC therapy, when the irradiating the intramammary nodes and supraclavicular nodes.

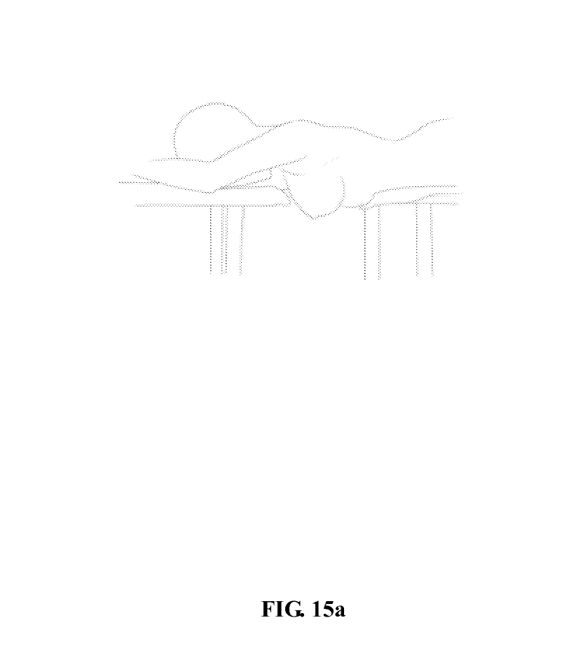

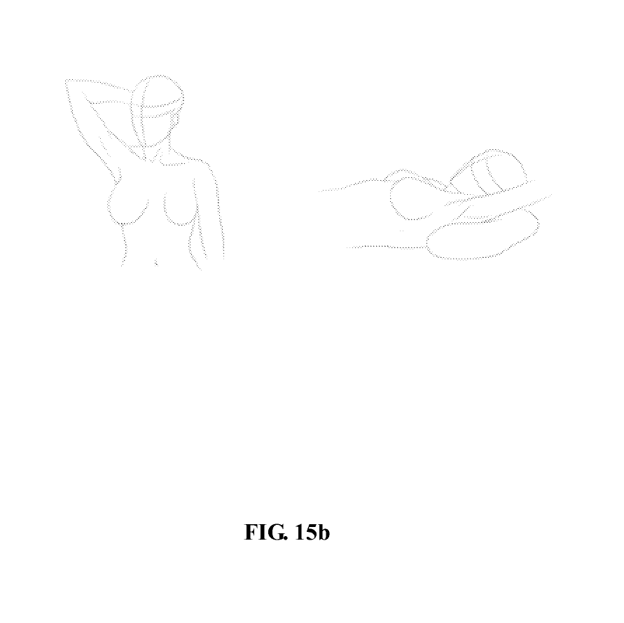

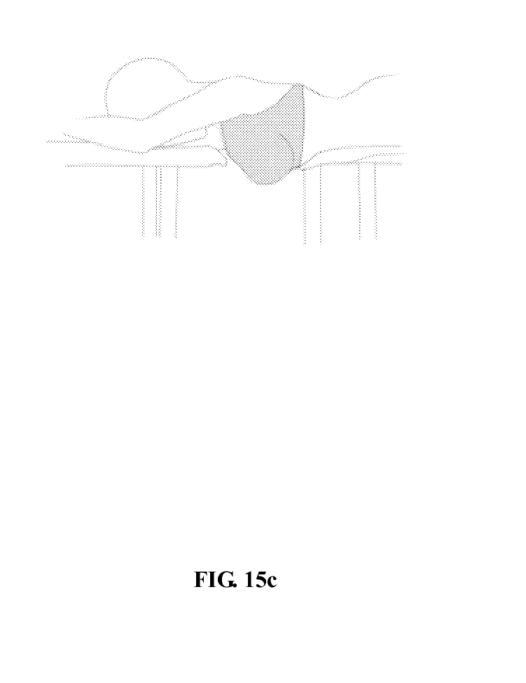

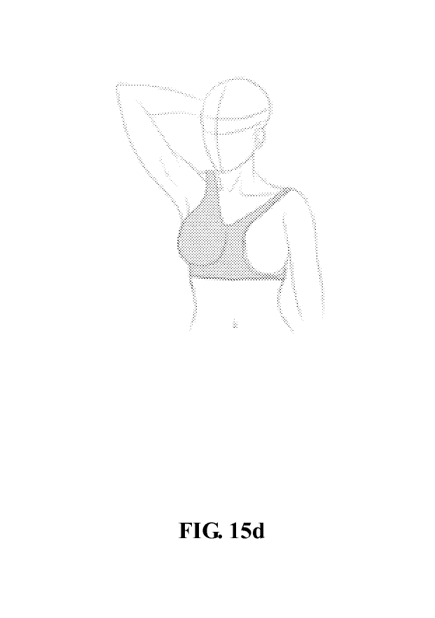

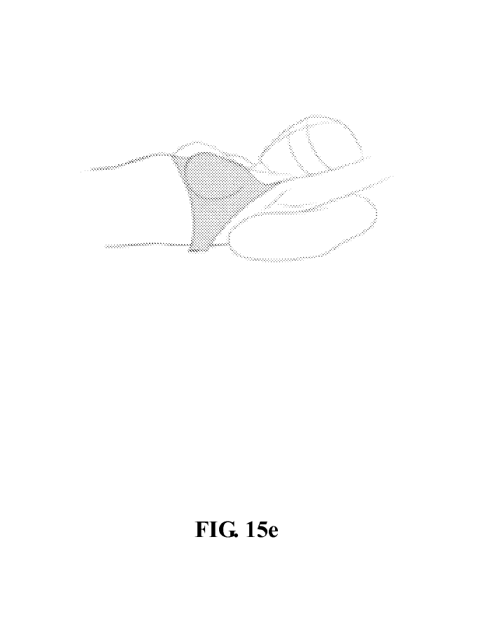

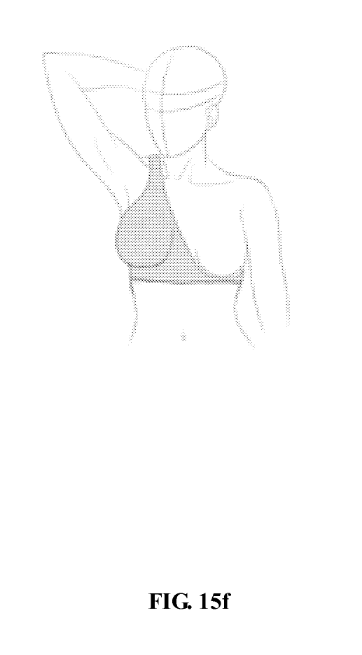

FIG. 15a illustrates a patient in the prone position, which can be used to simulate the treatment. FIG. 15c illustrates the patient wearing the bra in the prone position, while FIG. 15e illustrates the patient wearing the bra in the supine position used for planning and treating the patient. FIGS. 15d and 15f are further illustrations of the bra which can be used according to an aspect of the present disclosure.

Also contemplated is a bite block immobilizer that can be produced using the rapid prototyping techniques herein described, including 3D printing. In the area of the head, if the upper jaw/upper bite and hard palate are immobilized, then the entire head and skull are immobilized in the same position. During stereotactic radial surgery for treating brain lesions with large dose of radiation, for example, in one-three fractions, it is critical that the head be immobilized with sub-millimeter accuracy.

A cone beam CT or laser scan of the patient can be used for the upper jaw/bite and hard palate, and a custom bite immobilizer can be generated. Computer software can segment out the critical area of the scan corresponding to the upper jaw/bite and hard palate so that a custom fitting mold of a patient's upper bite and palate can be generated. In addition, the library of immobilizing devices can be referred to in selecting a bite block immobilizer, which can then be customized for the patient so that a custom fitting mold of the patient's upper bite and palette can be generated. An STL (stereo lithography) file can then be generated and sent to a 3D printer or other rapid prototyping device to generate an exact mold with the correct thickness, shape and size to fit the patient's mouth.

The bite block immobilizer is a support structure to which the immobilizer mold can be attached, and this support structure can then be attached to or positioned on the treatment couch. Similarly, other support structures discussed herein, including the headrest and the support structure for the leg or the arm, can also be attached to the treatment couch.

FIG. 4 illustrates device generation engine 50 according to an aspect of the present disclosure. Device generation engine 50 may be provided as a stand-alone computing device located on site or off-site or may be configured as several processors and software working in tandem. Device generation engine 50 includes an operating system 71 that runs the device, processor 73, which may be one or more automated data processors, and memory 59, which may be RAM, ROM provided as a single device or as a series of devices.

Device generation engine 50 can receive medical imaging data input via network interface 72 to the system and input image processing 56 can receive and process the data. Controller 58 of device generation engine shown in FIG. 4 can control overall processing of the device generation application.

Using user interface module 53, the user, such as a radiologist, an oncologist, a radiology technician or the like, can visualize the patient using the medical imaging data received by input image processing 56. Using user interface module 53, the user can reposition the patient as needed and also redisplay the patient in the repositioned position to arrive at an optimal position for the patient. Image renderer 61 can provide to the user images of the repositioned patient based on the medical imaging data processed by input image processing 56. That is, medical imaging data, such as a CT data can be three-dimensional so that further images of the patient can be rendered to the user based on the same set of medical imaging data. Treatment planner 62 can facilitate the user making treatment choices using various radiation fields visualized on the display.

Device generator 54 can be used by a user to access device library 65 to retrieve a suitable immobilization device and support structure for underneath the patient to which the immobilization device is attached. The image of the repositioned patient together with the immobilization device and support structure can be rendered by image renderer 61 and displayed to the user. Further repositioning of the patient may be necessary and image renderer 61 can provide further images of the further repositioned patient based on the same set of input medical imaging data processed by input image processing 56. Treatment planner 62 can then be used again to fine-tune the treatment planned for the further repositioned patient. If necessary, the user can reject the first-selected immobilization device and chose a second device more suitable for the further repositioned patient's position. Device customizer 63 can take the file for the immobilization device and support structure retrieved from device library 65 and customize automatically the immobilization device and support structure according to the size and position of the patient. Thus, the repositioned patient or further repositioned patient together with immobilization device and support structure therefore can be visualized by the user based on the rendering of the image by image renderer 61.

In addition, device generation engine 50 can enable the user to include markings on the surface of the immobilization device. Such markings can include target markings, including one or more iso-center markings or beam entry points, radiation field shape indicators, radiation field border markings, in-vivo dosimetry markings, bolus build-up material markings, OAR markings and the like.

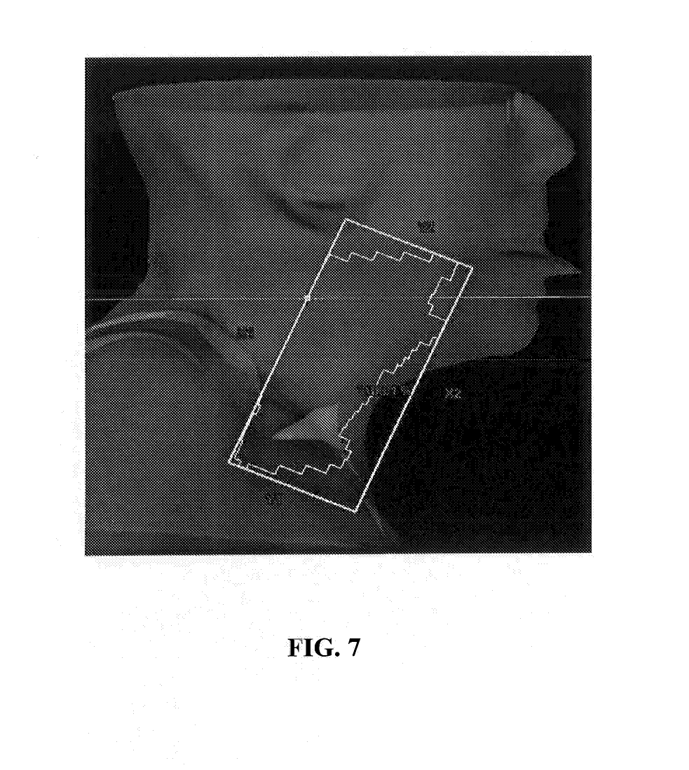

The custom markings can aid the technician in patient set-up when positioning the patient in the imaging machine or in the radiation providing machine. Using the radiation treatment plan, the treatment planning system can generate target markings on the custom device, for example, on the custom head mask. An example of such custom markings are shown in FIG. 7.

Device markings generator 55 can be used to mark the image and/or the prototype to be produced to aid the treatment technician in positioning the treatment apparatus. Such markings can include markings to show where the radiation dosage is to be applied, where the fields of radiation are to be induced, and where the critical area to be avoided are to be located.

Once the positioning and repositioning of the patient is complete, information or data about the immobilization device and, if necessary, the customized support structure for the immobilization device can be sent to a 3D printer or other prototyping device located on site or off site using 3D printer interface 57. 3D printer interface 57 may communicate with the 3D printer or other prototyping equipment using network interface 72. For example, network interface 72 may use TCP/IP or other packet-based communication. Network interface 72 may communicate with a CT imaging installation or other medical imaging system via the Internet or a local network. Similarly, network interface 72 may communicate with the 3D printer or other prototyping equipment using Internet protocol or other technology. Network interface 72 may be connected to a modem (not shown) and/or a wireless router (not shown), and may communicate with the network using a wired or wireless connection, using a satellite link or other means.

In addition, patient comfort can be enhanced because the customized immobilization devices are more comfortable than conventional head masks, due to their better fit. Further, when patients are more comfortable, they tend to move less during treatment. This is very important during simulation and during radiation treatment. Improved treatment outcomes can be achieved due to the increased patient safety, increased patient comfort and thus reduced likelihood of patient movement, and the reduced likelihood of treatment errors, as a result of the visual cues provided to the therapist.

Further, the customized immobilization device can be made with cutouts for the patient's eyes and nose. Also, they can include custom nose plugs, custom eye shields, and can be designed for specific treatment applications. For example, if the patient loses weight during treatment, a more conformal mask could thus be designed and made. The size, shape and other parameters and settings of the previous immobilization device for the patient could be saved in the system so that a newer immobilization device, if required, with a further customization could be easily designed and made. In this way, another CT simulation, with its attendant risks, costs and radiation to the patient can be avoided.

Also shown in FIG. 2 is a 3D printer communicatively connected to device generation engine 50 illustrated in FIG. 4 and shown in FIG. 2 as the adaptable 3D immobilization component. Thus, according to an aspect of the present disclosure, the graphical user interface module 53 shown in FIG. 4 of device generation engine 50 allows manipulation and creation onscreen of the immobilization device, and then once complete, instructions based on the generated immobilization device viewed on screen can be transmitted directly or indirectly to the 3D printer where all or most or some of the immobilization device can be automatically generated. For example, an entire head and neck mask, including a bolus, can be generated by the 3D printer. Alternatively, portions of the head and neck mask, such as the bolus, can be generated by the printer and added to a standard head and neck mask size for the patient that has been generated elsewhere. For example, device generation engine 50 can output a CAD file or more than one CAD files representing immobilization device so that the 3D printer can manufacture the treatment device.

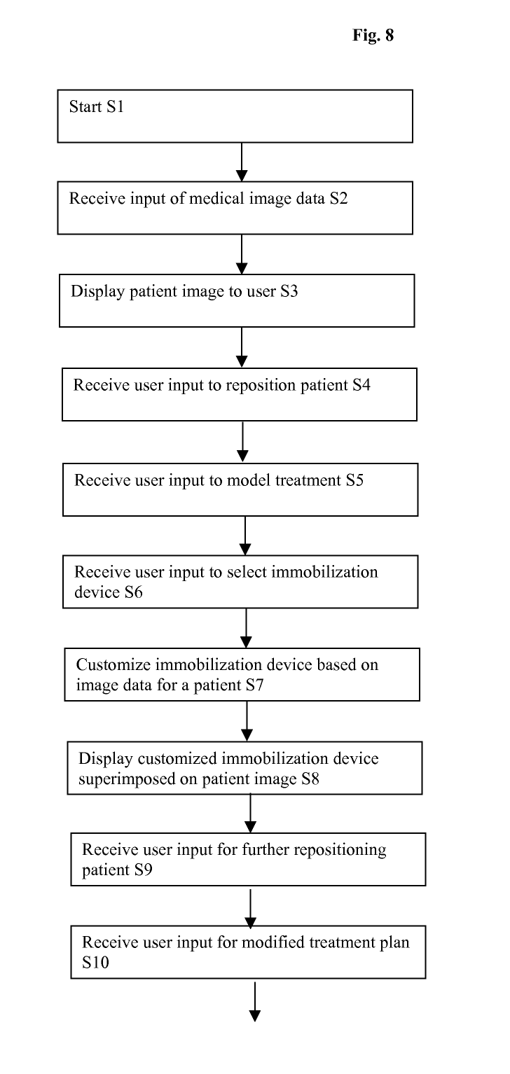

An operation of the system is illustrated in the flowchart provided in FIG. 8. After the system is started at S1, at S2 medical image data, such as CT imaging data, is transmitted or uploaded from a portable memory device to device generation engine 50.

At S3, an image of the patient based on such imaging data may be displayed to the patient. At S4, the user's input to reposition the patient may be received via user interface module 53 (shown in FIG. 4). Such repositioning may be possible because the original medical imaging data is 3D data sufficient to generate an image with a repositioned patient. The repositioned patient image can then be displayed. The display may be located near by of offsite from device generation engine 50. At S5, User can then use radiation planning software to model treatment.

At S6, user can select one or more immobilization devices from device libraries. For example, a variety of such devices can be displayed to the user or just a list of names and/or descriptions of such devices can be displayed. Support structures for the selected immobilization device, for example, a headrest to which the immobilization device is attachable, can be automatically selected by the system according to the immobilization device selected, or can be selected by the user.

At S7, the immobilization device may then be automatically customized based on the image data to fit the patient or may be customized by the user for the patient, for example, by comparing the size and fit to the image of the patient displayed on screen.

At S8, the selected immobilization device can be displayed superimposed on the patient image. At S9, further repositioning and manipulation input from the user can be received. At S10, the user can further plan treatment based on the repositioning.

At S11, user input can be received for device marking to aid the technician positioning the actual patient on the treatment couch and positioning the treatment equipment, and at S12 the marking can be customized for the patient according to the treatment plan.

At S13, the immobilization device data can be transmitted to the device generator, such as the 3D printer.

A computer system may include one or more processors in one or more physical units for performing the system, method and for executing the computer-readable medium, according to the present disclosure. Further, these computers or processors, including the device generation engine or components thereof, may be located in a cloud or offsite or may be provided in local enterprise setting or off premises at a third-party contractor site. One or more component of the device generation engine may be provided as software on a processor-readable medium, such as a hard drive, disk, memory stick, or the like, may be encoded as hardware, or may be provided as part of a system, such as a server computer.

Medical imaging information or other information stored may be stored in a cloud or may be stored locally or remotely. The computer system or systems that enable the viewer or user to interact with content or features can include a graphical user interface or may include graphics, text and/or other types of information, and may interface with the user via desktop, laptop computer, or via other types of processors, including handheld devices, telephones, mobile telephones, smart phones, tablets or other types of other communication devices and systems.

Various types of memory may be provided in the computer for storing the information or the images for the patient including random access memory, secondary memory, EPROM, PROM (programmable read-only memory), removable storage units, or a combination of the foregoing. In addition, the communication interface between the major components of the system, or between components of the device generation engine 50, can include a wired or wireless interface communicating over TCP/IP or via other types of protocols, and may communicate via a wired, cable, fiber optics, line, a telephone line, a cellular link, a satellite link, a radio frequency link, such as a Wi-Fi or Bluetooth, LAN, WAN, VPN, the World Wide Web, the Internet, or other such communication channels or networks or a combination of the foregoing.

While the preferred embodiments of the invention have been illustrated and described, modifications and adaptations, and other combinations or arrangements of the structures and steps described come within the spirit and scope of the application and the claim scope.

What is claimed is:

1. A method of customizing, based on medical imaging data for a patient positioned on a treatment couch, a medical immobilization device, the method comprising:
receiving, by an automated data processor, the medical imaging data;
receiving, by the automated data processor, a selection of an immobilization device configured to anchor only to at least one boney structure of a body part of the patient to immobilize the body part of the patient, the immobilization device configured to mask only partially the body part of the patient;
customizing, by the automated data processor, the selected immobilization device according to the medical imaging data; and
outputting, by the automated data processor, a signal for producing the immobilization device according to the customized immobilization device.

2. The method of claim 1, wherein the patient medical imaging data comprises at least one of a cone beam CT image data, a CT scanner image data, an x-ray image data, an MRI image data, or a laser system image data.

3. The method of claim 1, wherein the at least one boney structure consists of at least one orbital area and the body part is the head.

4. The method of claim 1, wherein the at least one boney structure consists of at least one orbital area and a chin, and the body part is the head.

5. The method of claim 1, wherein the at least one boney structure consists of an elbow and a shoulder.

6. The method of claim 1, wherein the at least one boney structure consists of a knee and a groin area.

7. The method of claim 1, wherein the immobilization device is attachable to a support structure positioned underneath the patient on the treatment couch, and
further comprising outputting, by the automated processor, a second signal for producing the support structure to which the medical immobilization device is attachable.

8. The method of claim 1, further comprising:
receiving, by the automated processor, a repositioning instruction and repositioning an image of the patient according to the repositioning instruction, the repositioning performed based on the received medical imaging data without obtaining further imaging data from the patient.

9. The method of claim 8, further comprising:
generating a display comprising the immobilization device superimposed on the body part of the patient on the repositioned image.

10. The method of claim 1, wherein the method further comprises:
receiving, by the automated processor, an instruction for adding a marking to the medical immobilization device, including an isocenter marking; and
outputting a signal for marking the medical immobilization device according to the instruction for adding the marking.

11. The method of claim 1, wherein the immobilization device is attachable to a support structure positioned underneath the patient on the treatment couch, and wherein the support structure comprises a custom headrest.

12. The method of claim 1, wherein the immobilization device is attachable to a support structure positioned underneath the patient on the treatment couch, and wherein the support structure comprises an arm support structure.

13. The method of claim 1, wherein the immobilization device is attachable to a support structure positioned underneath the patient on the treatment couch, and wherein the support structure comprises a leg support structure.

14. The method of claim 1, wherein the immobilization device is attachable to a support structure positioned underneath the patient on the treatment couch, and
wherein the immobilization device comprises a custom bite block and custom bit mold.

15. The method of claim 1, wherein the immobilization device comprises a bite block.

16. The method of claim 1, wherein the immobilization device comprises a brazier.

17. The method of claim 1, wherein the immobilization device is attachable to a support structure positioned underneath the patient on the treatment couch, and wherein the immobilization device comprises a custom torso immobilizer.

18. The method of claim 1, wherein the immobilization device is attachable to a support structure positioned underneath the patient on the treatment couch, and wherein the immobilization device comprises a custom hip immobilizer.

19. The method of claim 1, wherein the immobilization device is attachable to a support structure positioned underneath the patient on the treatment couch, and wherein the immobilization device comprises a custom back immobilizer.

20. The method of claim 1, wherein the signal output for producing the immobilization device is transmitted to a 3D printer.

21. The method of claim 1, wherein the method further comprises:
receiving, by the computer, a three dimensional image of the patient; and
outputting the three dimensional image of the patient to a user, before receiving the medical immobilization device customization instruction.

22. A method of customizing, based on medical imaging data for a patient positioned on a treatment couch, a brazier, the method comprising:
receiving, by an automated data processor, the medical imaging data obtained with the patient in a prone position;
receiving, by the automated data processor, a selection of a brazier immobilization device configured to hold a breast of the patient;
outputting, by the automated data processor, a signal for producing the brazier according to the selection; and
positioning the patient in a supine position using the brazier.

23. The method of claim 22, further comprising causing, by the automated data processor, display of an image of the patient in a supine position without obtaining further imaging data from the patient.
